(19) United States
(12) Patent Application Publication
(10) Pub. No.: US 2006/0242076 A1
(43) Pub. Date: Oct. 26, 2006

(54) Transmission device, reception device, transmission method, reception method, transmission program, reception program, and computer-readable storage medium

(75) Inventors: Fumihiro Fukae, Sakurai-shi (JP); Hitoshi Naoe, Kitakatsuragi-gun (JP); Koji Sakai, Osaka (JP); Shohei Osawa, Tenri-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/390,268

(22) Filed: Mar. 28, 2006

(30) Foreign Application Priority Data
Apr. 26, 2005 (JP) 2005-128533

(51) Int. Cl. G06Q 99/00

(52) U.S. Cl. 705/57; 705/59

(57) ABSTRACT

A transmission device is capable of transmitting data to a reception device via a transmission route and includes a digital content storage section for storing data under copyright protection. The data stored in the digital content storage section includes protection information for indicating whether the data is under copyright protection or not. The transmission device includes a copyright protection detection section for detecting whether data, transmission of which has been instructed, is under copyright protection or not and a transmission disallowance notification section for transmitting, to the reception device, transmission disallowance data indicating that the data is incapable of being transmitted because of copyright protection when it is detected that the data is under copyright protection. Therefore, it is possible to provide a transmission device and a reception device which keeps a user from being confused when the user instructs to transmit data incapable of being copied.

This non-provisional application claims priority under 35 U.S.C. § 119(a) on Patent Application No. 2005-128533 filed in Japan on Apr. 26, 2005, the entire contents of which are hereby incorporated by reference.

### FIELD OF THE INVENTION

The present invention relates to a transmission device and a reception device for transmitting data which needs/does not need copyright protection.

### BACKGROUND OF THE INVENTION

Recently, as a mobile phone gets multi-functional, people often photograph with ease by using a camera function with high resolution, store the photographed images in a storage medium such as a main body of the mobile phone and an SD card, and see the images. Generally, an image personally photographed by a mobile phone is data which does not need copyright protection.

Further, with prevalence of the Internet, it is possible to obtain, via a suitable accounting system, data of an image which needs copyright protection and to download the image from a server so as to store the image in a mobile phone.

Some of the data which needs copyright protection needs encryption in copying, and some of the data cannot be copied.

FIG. 10 illustrates an example of a conventional digital content transmission system (see Document 1: Japanese Unexamined Patent Publication No. 324097/2000 (Tokukai 2000-324097); published on Nov. 24, 2000). A transmission device 501 is a device capable of transmitting digital data, such as a mobile phone, a PDA (Personal Digital Assistance), and a PC (Personal Computer).

A digital content storage section 511 is a storage section for storing digital data including a content such as an image, a video, and audio. A protection information detection section 512 outputs copyright protection information detected from the digital data. A selection section 513 outputs the digital data to a communication section 514 when the copyright protection information indicates “copiable”. The selection section 513 does not output the digital data to the communication section 514 when the copyright protection information does not indicate “copiable”.

The communication section 514 transmits the digital data to a reception device 502 via a transmission route 503. Examples of the reception device 502 include a device such as a TV. The digital data received by a communication section 521 is decoded by a decoding section 522. When the decoded data is image data, an image output control section 523 controls output of the image and a display section 524 displays the image.

With the arrangement, a content which is not “copiable”, namely, which needs copyright protection, is not outputted to the transmission route 503. Therefore, the arrangement prevents the digital data including the content which needs copyright protection from being copied by a reception device via the transmission route 503.

However, the conventional technique has a problem. Namely, because digital data under copyright protection is not transmitted when a user instructs transmission of the digital data, the user cannot understand why the reception device is incapable of receiving the digital data, which causes a trouble.

First, let us consider such an application that an image is transmitted from a mobile phone to a TV and is displayed on the TV. It is assumed that the mobile phone stores data of an image photographed by a built-in camera and data of an image downloaded via the Internet. The data of the image photographed by the built-in camera is generally data which does not need copyright protection and is copiable. On the other hand, the data of the image downloaded via the Internet is not copiable due to copyright protection.

It is assumed that the image is transmitted by pressing a predetermined transmission button after selecting the image. When the image incapable of being copied is selected, the image is not transmitted even when the transmission button is pressed. Therefore, no image is displayed on the TV.

Under such circumstances, even when a display screen of the mobile phone displays whether the selected image can be copied or not, it is difficult for the user to determine whether the image can be copied or not because the user normally sees a TV screen while pressing the button.

Further, Document 1 describes such an arrangement that: data which needs copyright protection is outputted to a TV having no recording function by deteriorating the data. However, the data may be outputted so that the data is deteriorated in a manner different from what the copyright holder intends, with a result that the copyright of the data is not protected properly. Further, in a case of digital data incapable of being outputted under a deteriorated condition, there is no choice but giving up the transmission. At that time, because no image is outputted to the TV, the user may be confused.

### SUMMARY OF THE INVENTION

The present invention was made in view of the foregoing problems. An object of the present invention is to realize a transmission device and a reception device which keeps a user from being confused when the user instructs transmission of data which cannot be copied.

In order to achieve the object, the transmission device according to the present invention is a transmission device, which is capable of transmitting data to a reception device via a transmission route and (i) stores data under copyright protection inside the transmission device or (ii) is connectable with a storage medium storing the data under copyright protection, the transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection.

The transmission method according to the present invention is a transmission method of a transmission device which is capable of transmitting data to a reception device via a transmission route and (i) stores data under copyright protection inside the transmission device or (ii) is connectable with a storage medium storing the data under copyright protection, the method including: a copyright protection detection step for detecting whether data, transmission of which has been instructed, is under copyright protection or not based on protection information for indicating whether the data is under copyright protection or not; and a transmission disallowance notification step for transmitting, to the reception device, transmission disallowance data indicating that the data is incapable of being transmitted because of copyright protection when it is detected that the data is under copyright protection.

Here, the protection information may be embedded in data or may be stored in a protection information storage section so that the protection information corresponds to data identification information for identifying data. In a case where the protection information is embedded in the data, a protection information detection section detects the embedded protection information in reading out the data. Further, in a case where the data identification information and the protection information are stored in the protection information storage section so that the data identification corresponds to the protection information, the protection information detection section detects the protection information by reading out, from the protection information storage section, the protection information corresponding to the data identification information of data, transmission of which has been instructed.

With the arrangement or the method, it is possible to detect whether the data, transmission of which has been instructed, is under copyright protection or not based on the protection information included in the data or based on the protection information stored so as to correspond to the data. When the data is under copyright protection, transmission disallowance data indicating that transmission of the data is not allowed is transmitted to the reception device.

As a result, it is possible to prevent data under copyright protection from being copied. Further, because the reception device is capable of outputting the transmission disallowance data, the user can understand that the data is incapable of being transmitted because of copyright protection. As a result, in a case where the user operates the transmission device so as to transmit the data to the reception device, even when the data cannot be copied because of copyright protection, the user is not confused.

Further, in order to solve the problem, the reception device according to the present invention is a reception device, connected via a transmission route with a transmission device which stores data under copyright protection inside the transmission device or is connectable with a storage medium storing the data under copyright protection, the transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection, the reception device including: an output section for outputting information corresponding to the transmission disallowance data; and an output control section for causing, upon receiving the transmission disallowance data, the output section to output the information corresponding to the transmission disallowance data.

Further, in order to solve the problem, the reception method according to the present invention is a reception method of a reception device connected via a transmission route with a transmission device which stores data under copyright protection inside the transmission device or is connectable with a storage medium storing the data under copyright protection, the transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection, the reception device including an output section for outputting information corresponding to the transmission disallowance data, the reception method including an output step for causing, when the transmission disallowance data is received, the output section to output the information corresponding to the transmission disallowance data.

With the arrangement and the method, it is possible to receive, from the transmission device, data indicating that the data, transmission of which has been instructed, is incapable of being transmitted because of copyright protection, and it is possible to output information corresponding to the data. As a result, the user can easily understand that the data is incapable of being transmitted because of copyright protection. As a result, in a case where the user operates the reception device so as to receive data from the transmission device, even when the data cannot be copied because of copyright protection, the user is not confused.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating a structure of a digital content transmission system according to a first embodiment.

FIG. 2 illustrates a structure of digital data.

FIG. 3 illustrates an example of a protection information table stored in a protection information storage section included in a transmission device.

FIG. 4 is a flowchart illustrating how transmission of data is carried out by a transmission device according to the first embodiment.

FIG. 5 is a flowchart illustrating how reception of data is carried out by a reception device according to the first embodiment.

FIG. 6 is a block diagram illustrating a modification example of the transmission device according to the first embodiment.

FIG. 7 is a block diagram illustrating a structure of a digital content transmission system according to a second embodiment.

FIG. 8 is a block diagram illustrating a structure of a digital content transmission system according to a third embodiment.

FIG. 9 is a block diagram illustrating a structure of a digital content transmission system according to a fourth embodiment.

FIG. 10 is a block diagram illustrating a structure of a conventional digital content transmission system.

### DESCRIPTION OF THE EMBODIMENTS

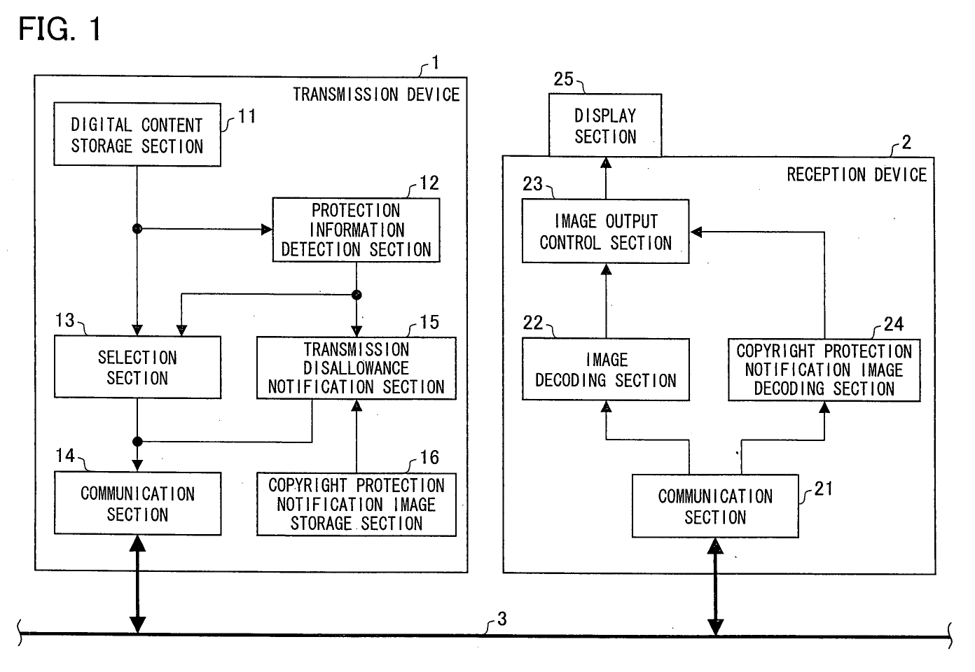

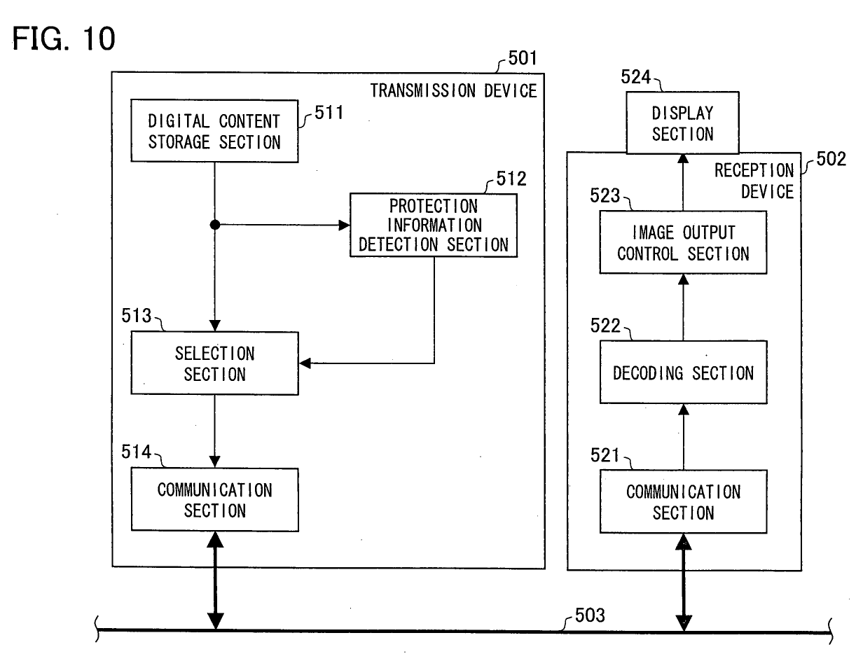

With reference to FIGS. 1 through 10, the following explains embodiments of the present invention.

### Embodiment 1

FIG. 1 is a block diagram illustrating a transmission device 1 and a reception device 2 according to an embodiment 1 of the present invention. The transmission device 1 transmits digitalized data (digital data) to the reception device 2. Examples of the transmission device 1 include a mobile phone, a PDA, and a PC. However, examples are not limited to them. The reception device 2 receives the digital data from the transmission device 1. The transmission device 1 transmits/receives the digital data to/from the reception device 2 via a transmission route 3.

The transmission route 3 allows transmission of the digital data. Examples of a physical form of the transmission route 3 include a wired transmission route of an electric signal such as a twist pair or a co-axis cable, an optical fiber such as plastic or glass, and a wireless transmission route such as an electromagnetic wave or an infrared ray. Any physical form is selectable.

Further, examples of a method for transmitting digital data include Ethernet (registered trademark), ATM, Token Ring, IEEE1394, and IrDA.

As illustrated in FIG. 1, the transmission device 1 includes a digital content storage section 11, a protection information detection section (copyright protection detection section) 12, a selection section 13, a communication section 14, a transmission disallowance notification section 15, and a copyright protection notification image storage section 16. Further, the transmission device 1 includes an operation section (not shown) and allows a user to instruct transmission of the digital data via the operation section.

The digital content storage section 11 is a section for storing digital data including a digital content such as digitalized still images and moving images. Examples of the digital data in the present embodiment include still images such as JPEG (Joint Photographic Experts Group) and moving images such as MPEG (Moving Picture Expert Group). However, the examples are not limited to them as long as the data needs copyright protection.

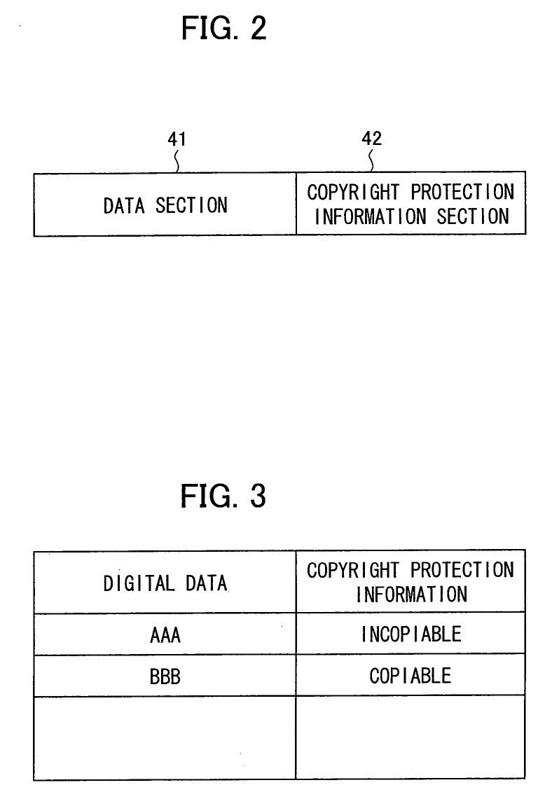

As illustrated in FIG. 2, digital data stored in the digital content storage section 11 includes a data section 41 and a copyright protection information section 42. The data section 41 is a region for storing data items such as digitalized still images and moving images.

The copyright protection information section 42 is a region for storing copyright protection information concerning the digital data. An example of the copyright protection information is CGMS (Copy Generation Management System). CGMS is a method for embedding a flag indicating “not copiable”, “copiable for one generation”, or “copiable” in the digital data. Note that the copyright protection information is not limited to this. The copyright protection information may have any form as long as the copyright protection information has information being not less than 1 bit and indicates whether “copiable” or not.

The protection information detection section 12 extracts digital data, transmission of which has been instructed, from the digital content storage section 11 and reads out copyright protection information from the copyright protection information section 42 embedded in the extracted digital data.

Further, the protection information detection section 12 outputs the detected copyright protection information to the selection section 13 and the transmission disallowance notification section 15. Note that the information outputted by the protection information detection section 12 may have any form as long as the information is not less than 1 bit and indicates whether “copiable” or not. In the present embodiment, the protection information detection section 12 outputs the copyright protection information included in the digital data without any modification.

Further, when the copyright protection information section 42 is not included in the digital data, the protection information detection section 12 outputs predetermined copyright protection information (copyright protection information indicating “copiable” in the present embodiment) to the selection section 13 and the transmission disallowance notification section 15.

The selection section 13 selects whether the digital data is to be transmitted or not based on the copyright protection information from the protection information detection section 12. When the copyright protection information indicates “copiable”, the selection section 13 reads out the digital data, transmission of which has been instructed, from the digital content storage section 11 and transmits the read out digital data to the transmission route 3 via the communication section 14. On the other hand, when the copyright protection information is not “copiable”, the selection section stops transmission of the digital data.

The copyright protection notification image storage section 16 stores an image (copyright protection notification image) being transmission disallowance data which indicates that: the digital data, transmission of which has been instructed, cannot be transmitted because of copyright protection. Note that the copyright protection notification image stored in the copyright protection notification image storage section 16 may be still-image data or moving-image data, and may have a format (data form) different from a format of the digital data stored in the digital content storage section 11.

Further, the copyright protection notification image storage section 16 may store a copyright protection notification image having been previously generated, or may store a copyright protection notification image generated by an image generation section (not shown) after the protection information detection section 12 reads out copyright protection information other than information indicative of “copiable”.

When the copyright protection information from the protection information detection section 12 is not “copiable”, the transmission disallowance notification section 15 transmits transmission disallowance data to the reception section 2 so as to notify that transmission is not allowed. Upon receiving copyright protection information which is not “copiable” from the protection information detection section 12, the transmission disallowance notification section 15 according to the present embodiment reads out the copyright protection notification image from the copyright protection notification image storage section 16 and transmits the read out copyright protection notification image to the reception device 2 via the communication section 14 and the transmission route 3.

Next, the following explains a structure of the reception device 2. The reception device 2 receives digital data having been transmitted from the transmission device 1 via the transmission route 3.

As illustrated in FIG. 1, the reception device 2 includes a communication section 21, an image decoding section 22, an image output control section (display control section) 23, and a copyright protection notification image decoding section 24, and is connected with a display section 25.

The communication section 21 transmits/receives digital data to/from the transmission device 1 via the transmission route 3. When the communication section 21 receives transmission disallowance data (copyright protection notification image data in the present embodiment) from the transmission device 1, the communication section 21 outputs the received copyright protection notification image data to the copyright protection notification image decoding section 24. On the other hand, when the communication section 21 receives digital data which is not the transmission disallowance data from the transmission device 1, the communication section 21 outputs the received digital data to the image decoding section 22.

The image decoding section 22 decodes the digital data received from the communication section 21 and outputs the decoded image to the image output control section 23.

The copyright protection notification image decoding section 24 decodes the copyright protection notification image data received from the communication section 21 and outputs the decoded copyright protection notification image to the image output control section 23.

Note that when a format of the copyright protection notification image data is identical with a format used in the image decoding section 22, the image decoding section 22 may serve also as the copyright protection notification image decoding section 24.

The image output control section 23 carries out a process for outputting the decoded image data to the display section 25. When an interface with the display section 25 is analog, the image output control section 23 carries out D/A conversion of the decoded image data. When the interface with the display section 25 is digital, the image output control section 23 outputs the decoded image data without any modification. Further, the image output control section 23 may output the decoded image data according to an interface (e.g. RGB or YCrCb) with the display section 25. The image output control section 24 may have any form as long as the image output control section 24 is capable of outputting a signal in accordance with the interface with the display section 25.

An example of the display section 25 is a liquid crystal display. The display section 25 displays an image according to control of the image output control section 23. Note that the display section 25 may be provided inside the reception device 2.

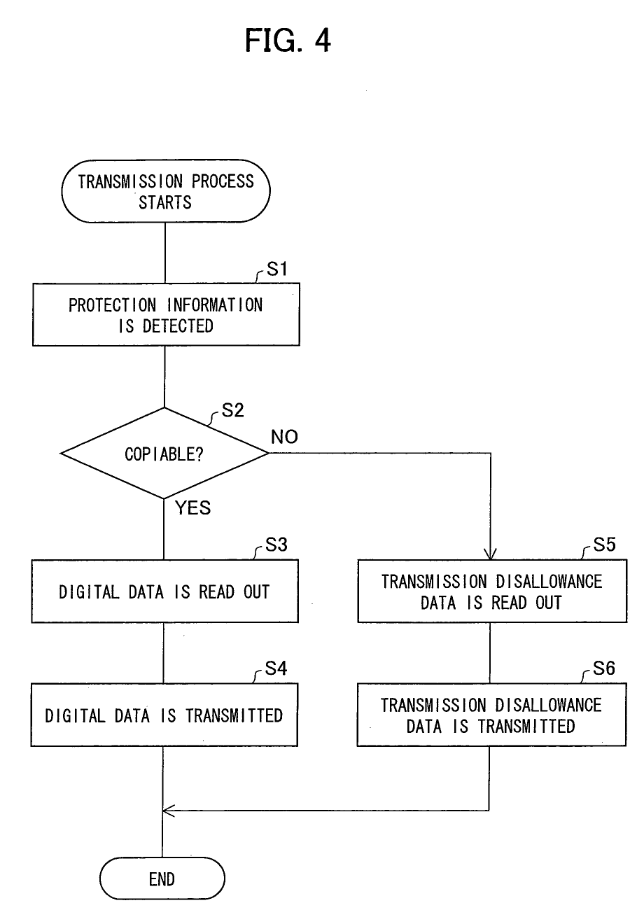

Next, with reference to a flowchart of FIG. 4, the following explains how transmission of digital data is carried out in the present embodiment.

When transmission of digital data is instructed, the protection information detection section 12 reads out the digital data, transmission of which has been instructed, from the digital content storage section 11 and detects copyright protection information from the copyright protection information section 42 included in the read out digital data (S1).

Then, the protection information detection section 12 outputs the detected copyright protection information to the selection section 13 and the transmission disallowance notification section 15.

Note that when the copyright protection information is not included in the digital data, the protection information detection section 12 outputs copyright protection information indicating “copiable” to the selection section 13 and the transmission disallowance notification section 15.

Next, upon receiving the copyright protection information, the selection section 13 and the transmission disallowance notification section 15 determines whether the received copyright protection information is “copiable” or not (S2).

When the copyright protection information is “copiable” (YES in S2), the selection section 13 reads out the digital data, transmission of which has been instructed, from the digital content storage section 11 (S3). After that, the selection section 13 transmits the read out digital data to the reception device 2 via the communication section 14 and the transmission route 3 (S4). Then, the process is finished.

On the other hand, when the copyright protection information is not “copiable” (NO in S2), the selection section 13 stops transmitting the digital data, transmission of which has been instructed, and the transmission disallowance notification section 15 reads out copyright protection notification image data from the copyright protection notification image storage section 16 (S5). Then, the transmission disallowance notification section 15 transmits the read out copyright protection notification image data to the reception device 2 via the communication section 14 and the transmission route 3 (S6). Then, the process is finished.

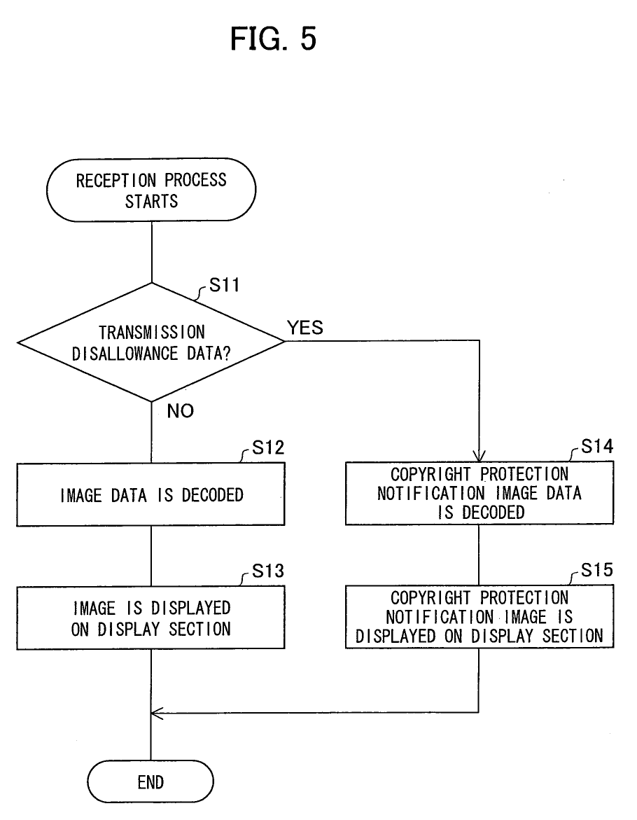

Next, with reference to a flowchart of FIG. 5, the following explains how reception of data is carried out by the reception device 2.

First, the communication section 21 determines whether the received data is transmission disallowance data (copyright protection notification image data in the present embodiment) or digital data other than the transmission disallowance data (image data in the present embodiment) (S11).

When the received data is the image data other than the copyright protection notification image data, the communication section 21 outputs the image data to the image decoding section 22. Then, the image decoding section 22 decodes the image data (S12). After that, the image output control section 23 performs a predetermined process (e.g. D/A conversion process) with respect to the image data decoded in S12 and displays the image on the display section 25 (S13). As a result, a user can see the image corresponding to the image data which the user has instructed to transmit.

On the other hand, when the received data is copyright protection notification image data, the communication section 21 outputs the copyright protection notification image data to the copyright protection notification image decoding section 24. Then, the copyright protection notification image decoding section 24 decodes the copyright protection notification image data (S14). After that, the image output control section 23 performs a predetermined process (e.g. D/A conversion) with respect to the copyright protection notification image data decoded in S14 and displays the copyright protection notification image on the display section 25 (S13).

As a result, the user can easily understand that the digital data which the user has instructed to transmit cannot be transmitted because of copyright protection.

Note that the foregoing explains a case where copyright protection information is embedded in digital data and the protection information detection section 12 detects the copyright protection information from the digital data. However, the storage location of the copyright protection information is not limited to this. For example, the copyright protection information may be managed in a location different from a location where digital data is stored.

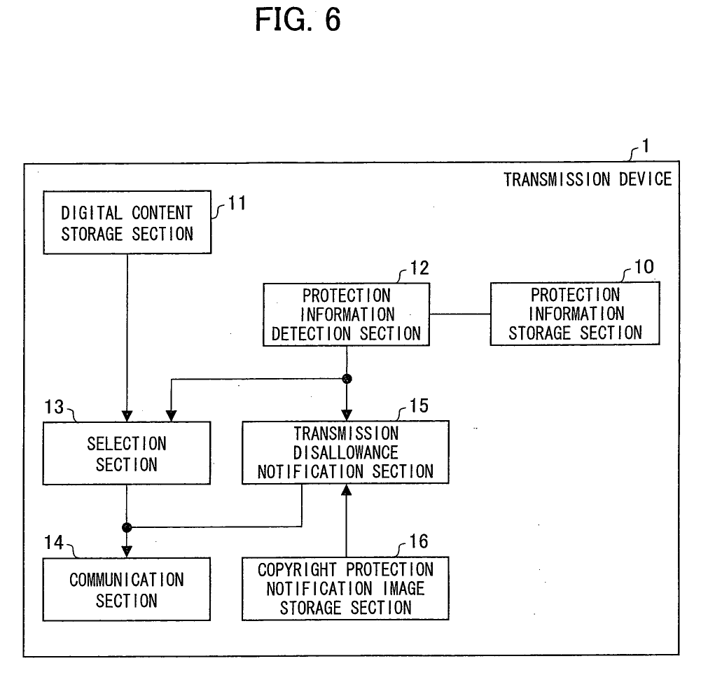

The transmission device 1 may have an arrangement illustrated in FIG. 6 for example. The transmission device illustrated in FIG. 6 includes a protection information storage section 10 for storing a protection information table in which (i) data identification information (here, name of data) for identifying each of digital data items stored in the digital content storage section 11 and (ii) copyright protection information for each of the digital data items correspond to each other. FIG. 3 illustrates an example of the protection information table stored in the protection information storage section 10. As illustrated in FIG. 3, the protection information storage section 10 stores, for example, digital data name “AAA” and copyright protection information “not copiable” so that the “AAA” and the “not copiable” correspond to each other.

When the transmission device 1 is instructed via the operation section (not shown) to transmit digital data, the protection information detection section 12 reads out, from the protection information storage section 10, copyright protection information corresponding to digital data name of the digital data, transmission of which has been instructed, and outputs the read out copyright protection information to the selection section 13 and the transmission disallowance notification section 15.

As described above, even in a case where copyright protection information is managed in a location different from a location where digital data is stored, the protection information detection section 12 is capable of outputting the copyright protection information to the selection section 13 and the transmission disallowance notification section 15 by referring to the protection information storage section 10. As a result, when the copyright protection information is not “copiable”, the transmission disallowance notification section 15 is capable of transmitting, to the reception device 2, transmission disallowance data (copyright protection notification image data in the present embodiment), which indicates that transmission of the digital data is not allowed.

### Embodiment 2

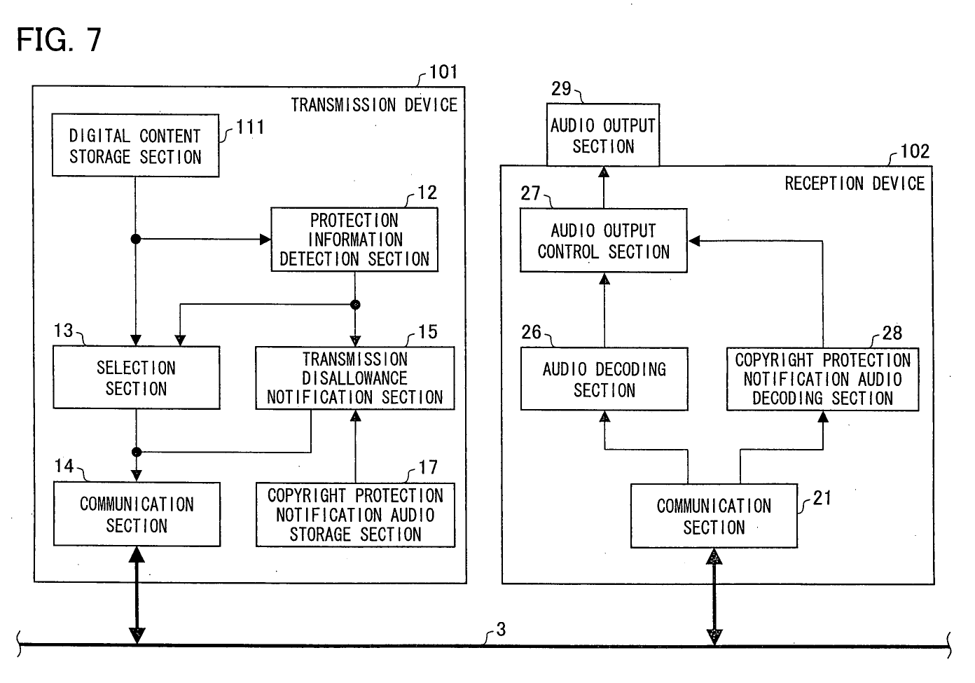

With reference to FIG. 7, the following explains another embodiment of the digital content transmission system according to the present invention. For convenience of explanation, members having the same functions as those explained in drawings of the embodiment 1 are given the same signs as the embodiment 1 and explanations thereof are omitted here.

FIG. 7 is a block diagram illustrating structures of a transmission device 101 and a reception device 102 according to the present embodiment.

The transmission device 101 is different from the transmission device 1 in that: the former includes a digital content storage section 111 instead of the digital content storage section 11 and includes a copyright protection notification audio storage section 17 instead of the copyright protection notification image storage section 16.

The digital content storage section 111 stores digital data including a digital content being digitalized audio data. An example of the digitalized audio data is MP3 (MPEG1 Audio Layer 3). However, the digitalized audio data is not limited to this as long as the data needs copyright protection. Further, as illustrated in FIG. 2, the digital data stored in the digital content storage section 111 includes a data section 41 and a copyright protection information section 42.

As a result, as with the embodiment 1, the protection information detection section 12 can read out digital data, transmission of which has been instructed, from the digital content storage section 111 and can read out copyright protection information from the copyright protection information section 42 included in the read out digital data.

The copyright protection notification audio storage section 17 stores audio data (copyright protection notification audio data) being transmission disallowance data for indicating that digital data, transmission of which has been instructed, cannot be transmitted because of copyright protection. Note that the copyright protection notification audio data stored in the copyright protection notification audio storage section 17 may have a format (data form) different from that of digital data stored in the digital content storage section 11.

Further, the copyright protection notification audio storage section 17 may store copyright protection notification audio data having been previously generated or may store copyright protection notification audio data generated by an audio content section (not shown) after the protection information detection section 12 has read out copyright protection information other than “copiable”.

Upon receiving copyright protection information other than information indicative of “copiable” from the protection information detection section 12, the transmission disallowance notification section 15 according to the present embodiment reads out copyright protection notification audio data as transmission disallowance data from the copyright protection notification audio storage section 17 and transmits the copyright protection notification audio data to the transmission route 3 via a communication section 14.

As described above, when digital data, transmission of which has been instructed, cannot be transmitted because of copyright protection, the transmission device 101 transmits copyright protection notification audio data being transmission disallowance data to the reception device 102.

Further, as illustrated in FIG. 7, the reception device 102 includes a communication section 21, an audio decoding section 26, an audio output control section 27, and a copyright protection notification audio decoding section 28, and is connected with an audio output section 29.

Note that the communication section 21 according to the present embodiment receives copyright protection notification audio data as transmission disallowance data and outputs the received copyright protection notification audio data to the copyright protection notification audio decoding section 28.

The audio decoding section 26 decodes digital data received from the communication section 21 and outputs the decoded audio data to the audio output control section 27.

The copyright protection notification audio decoding section 28 decodes the copyright protection notification audio data received from the communication section 21 and outputs the decoded copyright protection notification audio data to the audio output control section 27.

Note that in a case where the format of copyright protection notification audio data is the same as the format used in the audio decoding section 26, the audio decoding section 26 may serve also as the copyright protection notification audio decoding section 28.

The audio output control section 27 performs a process for outputting the decoded audio data to the audio output section 29. The audio output control section 27 performs, for example, D/A conversion of the decoded audio data and outputs thus obtained analog signal to the audio output section 29.

An example of the audio output section 29 is a speaker. The audio output section 29 outputs audio according to control of the audio output control section 27. Note that the audio output section 29 may be provided inside the reception device 102.

How transmission/reception of data are carried out in the present embodiment is the same as those of the embodiment 1 illustrated in FIGS. 4 and 5 except that: the former transmits/receives copyright protection notification audio data as transmission disallowance data and transmits/receives audio data as digital data. Therefore, detailed explanations of how transmission/reception of data are carried out in the present embodiment are omitted here.

With the present embodiment, when audio data which the user has instructed to transmit is outputted from the reception device 102, the user can understand that the audio data does not need copyright protection. Further, when copyright protection notification audio is outputted from the reception device 2, the user can easily understand that audio data which the user has instructed to transmit cannot be transmitted because of copyright protection.

### Embodiment 3

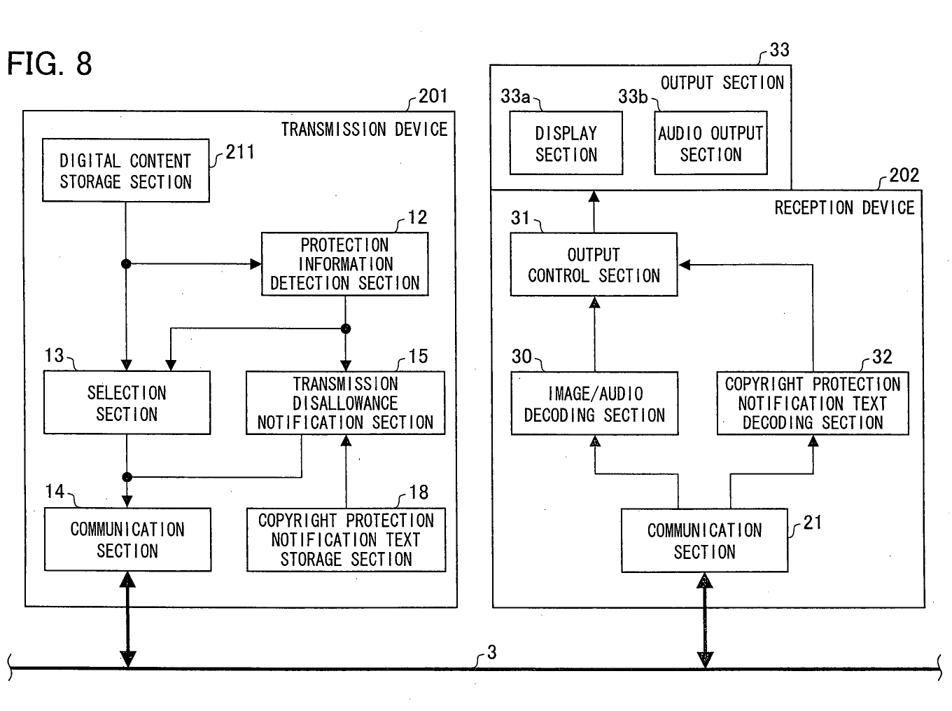

With reference to FIG. 8, the following explains further embodiment of the digital content transmission system according to the present invention. Note that for convenience of explanation, members having the same functions as those explained in drawings of the embodiment 1 are given the same signs and explanations thereof are omitted here.

FIG. 8 is a block diagram illustrating structures of a transmission device 201 and a reception device 202 according to the present embodiment.

The transmission device 201 is different from the transmission device 1 in that: the former includes a digital content storage section 211 instead of the digital content storage section 11 and includes a copyright protection notification text storage section 18 instead of the copyright protection notification image storage section 16.

The digital content storage section 211 stores digital data including a digital content such as digitalized still images, moving images, and audios. Examples of digital data include still images such as JPEG, moving images such as MPEG, and audio data such as MP3. However, the digital data is not limited to them as long as the data needs copyright protection. Further, as illustrated in FIG. 2, the digital data stored in the digital content storage section 211 includes a data section 41 and a copyright protection information section 42.

As a result, as with the embodiment 1, the protection information detection section 12 can read out digital data, transmission of which has been instructed, from the digital content storage section 211 and can read out copyright protection information based on the copyright protection information section 42 included in the read out digital data.

The copyright protection notification text storage section 18 stores text data (copyright protection notification text data) being transmission disallowance data for indicating that the digital data, transmission of which has been instructed, cannot be transmitted because of copyright protection. The copyright protection notification text storage section 18 may store copyright protection notification text data having been previously generated or may store copyright protection notification text data generated by a text content section (not shown) after the protection information detection section 12 has read out copyright protection information other than information indicative of “copiable”.

Upon receiving the copyright protection information other than information indicative of “copiable” from the protection information detection section 12, the transmission disallowance notification section 15 according to the present embodiment reads out copyright protection notification text data as transmission disallowance data from the copyright protection notification text storage section 18 and transmits the copyright protection notification text data to the transmission route 3 via a communication section 14.

As described above, when the digital data, transmission of which has been instructed, cannot be transmitted because of copyright protection, the transmission device 201 transmits the copyright protection notification text data being the transmission disallowance data to the reception device 202.

Further, as illustrated in FIG. 8, the reception device 202 includes a communication section 21, an image/audio decoding section 30, an output control section (display control section) 31, and a copyright protection notification text decoding section 32 and is connected with an audio output section 33.

Note that the communication section 21 according to the present embodiment receives copyright protection notification text data as transmission disallowance data and outputs the received copyright protection notification text data to the copyright protection notification text decoding section 32.

The image/audio decoding section 30 decodes digital data received from the communication section 21 and outputs the decoded image data or audio data to the output control section 31.

The copyright protection notification text decoding section 32 decodes the copyright protection notification text data received from the communication section 21 and outputs the decoded copyright protection notification text data to the output control section 31.

The output section 33 includes a display section 33a and an audio output section 33b. An example of the display section 33a is a liquid crystal display. Further, an example of the audio output section 33b is a speaker. Note that the output section 33 may be provided inside the reception device 202.

In order to output, to the output section 33, (i) image data and audio data received from the image/audio decoding section 30 and (ii) copyright protection notification text data received from the copyright protection notification text decoding section 32, the output control section 31 performs the following process with respect to the received data.

In a case where an interface with the display section 33a is analog, upon receiving decoded image data, the output control section 31 performs, for example, D/A conversion of the decoded image data and outputs thus obtained analog data to the display section 33a. Further, in a case where an interface with the display section 33a is digital, upon receiving decoded image data, the output control section 31 outputs the decoded image data to the display section 33a without any modification. Further, the output control section 31 may output the decoded image data according to the interface (e.g. RGB or YCrCb) with the display section 33a.

Further, upon receiving decoded audio data, the output control section 31 performs, for example, D/A conversion of the decoded audio data and outputs thus obtained analog data to the audio output section 33b.

Further, upon receiving decoded copyright protection notification text data, the output control section 31 causes the display section 33a to display characters corresponding to the text data or an image including the characters.

How transmission/reception of data are carried out in the present embodiment is substantially the same as those of the embodiment 1 illustrated in FIGS. 4 and 5 except that: the former transmits copyright protection notification text data as transmission disallowance data and transmits image data or audio data as digital data. Therefore, detailed explanations of how transmission/reception of data are carried out in the present embodiment are omitted here.

With the present embodiment, when digital data which the user has instructed to transmit is outputted as an image or audio from the reception device 202 without any modification, the user can understand that the image or audio does not need copyright protection. Further, when characters corresponding to copyright protection notification text data are displayed on the display section 33a connected with the reception device 202, the user can easily understand that digital data which the user has instructed to transmit cannot be transmitted because of copyright protection.

### Embodiment 4

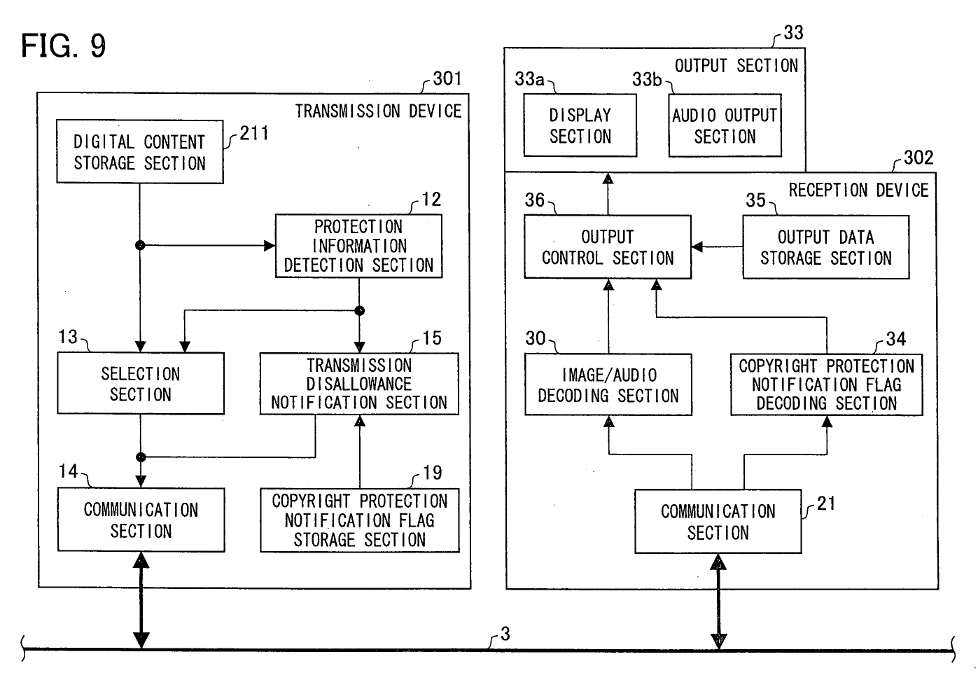

With reference to FIG. 9, the following explains further embodiment of the digital content transmission system according to the present invention. Note that for convenience of explanations, members having the same functions as those explained in drawings of the embodiments 1 through 3 are given the same signs and explanations thereof are omitted here.

FIG. 9 is a block diagram illustrating structures of a transmission device 301 and a reception device 302 according to the present embodiment.

The transmission device 301 is different from the transmission device 201 in that: the former includes a copyright protection notification flag storage section 19 instead of the copyright protection notification text storage section 18.

The copyright protection notification flag storage section 19 stores a flag signal (copyright protection notification flag signal) being transmission disallowance data for indicating that digital data, transmission of which has been instructed, cannot be transmitted because of copyright protection. The copyright protection notification flag storage section 19 may store a copyright protection notification flag signal having been previously generated or may store a copyright protection notification flag signal generated by a flag signal content section (not shown) after the protection information detection section 12 has read out copyright protection information other than information indicative of “copiable”.

Note that the copyright protection notification flag signal is constituted of a predetermined digital signal being not less than 1 bit (e.g. “1”)

Upon receiving copyright protection information other than information indicative of “copiable” from the protection information detection section 12, the transmission disallowance notification section 15 according to the present embodiment reads out a copyright protection notification flag signal as transmission disallowance data from the copyright protection notification flag storage section 19 and transmits the copyright protection notification flag signal to the transmission route 3 via a communication section 14.

As described above, when the digital data, transmission of which has been instructed, cannot be transmitted because of copyright protection, the transmission device 301 transmits a copyright protection notification flag signal being transmission disallowance data to the reception device 302.

Further, as illustrated in FIG. 9, the reception device 302 is different from the reception device 202 in that: the former includes a copyright protection notification flag decoding section 34 instead of the copyright protection notification text decoding section 32, includes an output control section (display control section, audio output control section) 36 instead of the output control section 31, and further includes an output data storage section 35.

The copyright protection notification flag decoding section 34 decodes copyright protection notification flag data received from the communication section 21 and outputs the decoded copyright protection notification flag data to the output control section 36.

The output data storage section 35 stores image data having been previously generated and indicating that digital data cannot be transmitted/received because of copyright protection. The output data storage section 35 stores an image including the characters “transmission is not allowed because of copyright protection” for example.

The output control section 36 performs the following process with respect to image data and audio data received from the image/audio decoding section 30 and outputs the processed data to the output section 33. Further, the output control section 36 reads out output data from the output data storage section 35 and outputs the read out output data to the output section 33 upon receiving a copyright protection notification flag signal from the copyright protection notification flag decoding section 34.

In a case where an interface with the display section 33a is analog, upon receiving decoded image data, the output control section 36 performs, for example, D/A conversion of the decoded image data and outputs thus obtained analog data to the display section 33a. Further, in a case where the interface with the display section 33a is digital, upon receiving decoded image data, the output control section 36 outputs the decoded image data to the display section 33a without any modification. Further, the output control section 36 may output the decoded image data according to the interface (e.g. RGB or YCrCb) with the display section 33a.

Further, upon receiving decoded audio data, the output control section 36 performs, for example, D/A conversion of the decoded audio data and outputs thus obtained analog data to the audio output section 33b.

How transmission of data is carried out by the transmission device 301 according to the present embodiment is substantially the same as that of the embodiment 1 illustrated in FIG. 4 except that: the former transmits a copyright protection notification flag signal as transmission disallowance data. Further, how reception of data is carried out by the reception device 302 according to the present embodiment is substantially the same as the embodiment 1 illustrated in FIG. 5 except that: (i) the former receives a copyright protection notification flag signal as transmission disallowance data and (ii) the output control section 31 having received a copyright protection notification flag signal reads out an image indicating that transmission/reception of digital data is not allowed because of copyright protection from the output data storage section 35 and outputs the image to the output section 33 in S13.

With the present embodiment, when digital data which the user has instructed to transmit is outputted as an image or audio from the reception device 302, the user can understand that the image or audio does not need copyright protection. Further, when an image indicating that transmission/reception of digital data is not allowed because of copyright protection is displayed on the display section 33a connected with the reception device 302, the user can easily understand that audio data which the user has instructed to transmit cannot be transmitted because of copyright protection.

Note that the foregoing explains a case where the output data storage section 35 stores image data indicating that transmission/reception of digital data is not allowed because of copyright protection. However, the present embodiment is not limited to this case. The present embodiment may be arranged so that: the output data storage section 35 stores audio data or text data indicating transmission/reception of digital data is not allowed because of copyright protection. In a case where the output data storage section 35 stores audio data, upon receiving a copyright protection notification flag signal, the output control section 36 outputs, to the audio output section 33b, audio indicating that transmission/reception of digital data is not allowed because of copyright protection. Further, in a case where the output data storage section 35 stores text data, upon receiving a copyright protection notification flag signal, the output control section 36 outputs, to the display section 33a, (i) characters indicating that transmission/reception of digital data is not allowed because of copyright protection or (ii) an image including the characters. As a result, the user can easily understand that digital data which the user has instructed to transmit cannot be transmitted because of copyright protection.

Further, in each of the embodiments, it is assumed that the digital content storage sections 11, 111, and 211 are provided inside the transmission devices 1, 101, 201, and 301. However, the present invention may be arranged so that: the digital content storage sections 11, 111, and 211 are provided outside the transmission devices 1, 101, 201, and 301, and are connected with the transmission devices 1, 101, 201, and 301.

As described above, the transmission device according to the present invention is a transmission device including: a copyright protection detection section for detecting whether data, transmission of which has been instructed, is under copyright protection or not based on protection information, the protection information being used to indicate whether the data is under copyright protection or not and being included in the data or the protection information being previously stored so that the protection information corresponds to the data; and a transmission disallowance notification section for transmitting transmission disallowance data indicating that the data is incapable of being transmitted because of copyright protection when it is detected that the data is under copyright protection.

As a result, it is possible to prevent data under copyright protection from being copied. Further, because the reception device can output the transmission disallowance data, the user can understand that the data cannot be transmitted because of copyright protection. As a result, for example, in a case where the user operates the transmission device so as to transmit data to the reception device, even when the data cannot be copied because of copyright protection, the user is not confused.

Further, the reception device according to the present invention is a reception device, connected via a transmission route with a transmission device which stores data under copyright protection inside the transmission device or is connectable with a storage medium storing the data under copyright protection, the transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection, the reception device including: an output section for outputting information corresponding to the transmission disallowance data; and an output control section for causing, upon receiving the transmission disallowance data, the output section to output the information corresponding to the transmission disallowance data.

Further, in order to solve the problem, the reception method according to the present invention is a reception method of a reception device connected via a transmission route with a transmission device which stores data under copyright protection inside the transmission device or is connectable with a storage medium storing the data under copyright protection, the transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection, the reception device including an output section for outputting information corresponding to the transmission disallowance data, the reception method including an output step for causing, when the transmission disallowance data is received, the output section to output the information corresponding to the transmission disallowance data.

With the arrangement, the user can easily understand that the data is incapable of being transmitted because of copyright protection. As a result, for example, in a case where the user operates the reception device so as to receive data from the transmission device, even when the data is incapable of being copied because of copyright protection, the user is not confused.

Further, the transmission device according to the present invention may be arranged so that the transmission disallowance data is image data.

Further, the reception device according to the present invention may be arranged so that the output section is a display section for displaying an image, and the output control section is a display control section for causing, upon receiving image data as the transmission disallowance data, the display section to display an image corresponding to the image data.

Further, the reception method according to the present invention may be arranged so that: the output section is a display section for displaying an image, and in the output step, when image data is received as the transmission disallowance data, an image corresponding to the image data is displayed on the display section.

With the arrangement and the method, the transmission device transmits image data indicating that data is incapable of being transmitted because of copyright protection, and the reception device displays an image corresponding to the image data on the display section. As a result, the user can visually understand that the data is incapable of being transmitted because of copyright protection.

Further, the transmission device according to the present invention may be arranged so that the transmission disallowance data is audio data.

It is preferable to arrange the reception device according to the present invention so that: the output section is an audio output section for outputting audio, and the output control section is an audio output control section for causing, upon receiving audio data as the transmission disallowance data, the audio output section to output audio corresponding to the audio data.

The reception method according to the present invention may be arranged so that: the output section is an audio output section for outputting audio, and in the output step, when audio data is received as the transmission disallowance data, audio corresponding to the audio data is outputted from the audio output section.

With the arrangement and the method, the transmission device transmits audio data indicating that data is incapable of being transmitted because of copyright protection, and the reception device outputs audio corresponding to the audio data from the audio output section. As a result, the user can aurally understand that the data is incapable of being transmitted because of copyright protection.

Further, the transmission device according to the present invention may be arranged so that the transmission disallowance data is text data.

Further, it is preferable to arrange the reception device according to the present invention so that: the output section is a display section for displaying an image, and the output control section is a display control section for causing, upon receiving text data as the transmission disallowance data, the display section to display a character corresponding to the text data.

The reception method according to the present invention may be arranged so that: the output section is a display section for displaying an image, and in the output step, when text data is received as the transmission disallowance data, a character corresponding to the text data is displayed on the display section.

With the arrangement and the method, the transmission device transmits text data indicating that data is incapable of being transmitted because of copyright protection, and the reception device displays a character corresponding to the text data in the display device. As a result, the user can visually understand that the data is incapable of being transmitted because of copyright protection. Further, because the transmission disallowance data is text data including only character information, it is possible to reduce the amount of the transmission disallowance data.

Further, the transmission device according to the present invention may be arranged so that the transmission disallowance data is predetermined flag data.

Further, it is preferable to arrange the reception device according to the present invention so that: the output section is a display section for displaying an image, and the output control section is a display control section for causing, upon receiving flag data as the transmission disallowance data, the display section to display an image or a character indicating that the data, transmission of which has been instructed, is incapable of being transmitted because of copyright protection.

It is preferable to arrange the reception method according to the present invention so that: the output section is a display section for displaying an image, and in the output step, when flag data is received as the transmission disallowance data, an image or a character indicating that the data, transmission of which has been instructed, is incapable of being transmitted because of copyright protection is displayed on the display section.

With the arrangement and the method, the transmission device transmits predetermined flag data indicating that data is incapable of being transmitted because of copyright protection. Further, upon receiving the flag data, the reception device displays the image or the character indicating that the data is incapable of being transmitted because of copyright protection. As a result, the user can visually understand that the data is incapable of being transmitted because of copyright protection. Further, because the transmission disallowance data is flag data, it is possible to further reduce the amount of the transmission disallowance data.

Further, the reception device according to the present invention may be arranged so that: the output section is an audio output section for outputting audio, and the output control section is an audio output control section for causing, upon receiving flag data as the transmission disallowance data, the audio output section to output audio indicating that the data, transmission of which has been instructed, is incapable of being transmitted because of copyright protection.

It is preferable to arrange the reception method according to the present invention so that: the output section is an audio output section for outputting audio, and in the output step, when flag data is received as the transmission disallowance data, audio indicating that the data, transmission of which has been instructed, is incapable of being transmitted because of copyright protection is outputted from the audio output section.

With the arrangement and the method, the transmission device transmits predetermined flag data indicating that the data is incapable of being transmitted because of copyright protection. Further, upon receiving the flag data, the reception device causes the audio output section to output audio indicating that the data is incapable of being transmitted because of copyright protection. As a result, the user can aurally understand that the data is incapable of being transmitted because of copyright protection. Further, because the transmission disallowance data is flag data, it is possible to further reduce the amount of the transmission disallowance data.

Note that the transmission device or the reception device may be realized by a computer. At that time, authentication program for realizing the transmission device or reception device by causing a computer to function as each of the sections, and a computer-readable storage medium for storing the program, are also within the scope of the present invention.

Lastly, blocks of the transmission devices 1, 101, 201, and 301 and the reception devices 2, 102, 202, and 302 may be constituted by a hardware logic, or may be realized by software with a CPU in the following manner.

Namely, each of the transmission devices 1, 101, 201, and 301 and the reception devices 2, 102, 202, and 302 includes a CPU (central processing unit) for executing a command of a control program for realizing each of the functions, a ROM (read only memory) for storing the program, a RAM for loading the program, a storage device (storage medium) such as a memory for storing the program and various items of data, and the like. Further, the object of the present invention also can be realized in such a manner that: each of the transmission devices 1, 101, 201, and 301 and the reception devices 2, 102, 202, and 302 is provided with a computer-readable storage medium for storing a program code (an executable program, an intermediate code program, and a source program) of the control program of each of the transmission devices 1, 101, 201, and 301 and the reception devices 2, 102, 202, and 302, which control program being software for realizing the above functions, and the computer (alternatively, a CPU or MPU) reads out and executes the program code stored in the storage medium.

Examples of the storage medium include: tapes such as a magnetic tape and a cassette tape, discs such as a magnetic disc (e.g. a floppy (registered trademark) disc or a hard disc) and an optical disc (e.g. CD-ROM/MO/MD/DVD/CD-R), cards such as an IC card (including a memory card) and an optical card, and a semiconductor memory such as a mask ROM, EPROM, EEPROM, and a flash ROM.

Further, the present invention may be arranged so that: the transmission devices 1, 101, 201, and 301 and the reception devices 2, 102, 202, and 302 are connectable with a communication network and the program code is supplied via the communication network. The communication network is not particularly limited. Examples of the communication network include: the Internet, an intranet, an extranet, a LAN, an ISDN, a VAN, a CATV communication network, a virtual private network, a telephone line network, a mobile phone communication network, a satellite communication network, and the like. Further, transmission medium which constitutes the communication network is not particularly limited. Examples of the transmission medium include: wired lines such as IEEE 1394, a USB, a power-line carrier, a cable TV line, a telephone line, and an ADSL and wireless lines such as an infrared ray (e.g. IrDA or remote controller), Bluetooth (registered trademark), 802.11 wireless, HDR, a mobile phone network, a satellite line, and a terrestrial wave digital network. Note that the present invention can be realized by using a computer data signal embedded in a carrier wave, which is the program code that is electrically transmitted.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

With the transmission device and reception device according to the present invention, a user is not confused even when data, transmission of which has been instructed, is incapable of being transmitted because of copyright protection. Therefore, the transmission device and the reception device according to the present invention are applicable to a transmission device (e.g. mobile phone) which transmits data under copyright protection and a reception device (e.g. TV).

What is claimed is:

1. A transmission device, which is capable of transmitting data to a reception device via a transmission route, and (i) stores data under copyright protection inside the transmission device or (ii) is connectable with a storage medium storing the data under copyright protection,
said transmission device comprising:
a copyright protection detection section for detecting whether data, transmission of which has been instructed, is under copyright protection or not based on protection information for indicating whether the data is under copyright protection or not; and
a transmission disallowance notification section for transmitting, to the reception device, transmission disallowance data indicating that the data is incapable of being transmitted because of copyright protection when it is detected that the data is under copyright protection.

2. The transmission device as set forth in claim 1, wherein the transmission disallowance data is image data.

3. The transmission device as set forth in claim 1, wherein the transmission disallowance data is audio data.

4. The transmission device as set forth in claim 1, wherein the transmission disallowance data is text data.

5. The transmission device as set forth in claim 1, wherein the transmission disallowance data is predetermined flag data.

6. A reception device, connected via a transmission route with a transmission device which stores data under copyright protection inside the transmission device or is connectable with a storage medium storing the data under copyright protection, said transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection,
said reception device comprising:
an output section for outputting information corresponding to the transmission disallowance data; and
an output control section for causing, upon receiving the transmission disallowance data, the output section to output the information corresponding to the transmission disallowance data.

7. The reception device as set forth in claim 6, wherein
the output section is a display section for displaying an image, and
the output control section is a display control section for causing, upon receiving image data as the transmission disallowance data, the display section to display an image corresponding to the image data.

8. The reception device as set forth in claim 6, wherein
the output section is an audio output section for outputting audio, and
the output control section is an audio output control section for causing, upon receiving audio data as the transmission disallowance data, the audio output section to output audio corresponding to the audio data.

9. The reception device as set forth in claim 6, wherein
the output section is a display section for displaying an image, and
the output control section is a display control section for causing, upon receiving text data as the transmission disallowance data, the display section to display a character corresponding to the text data.

10. The reception device as set forth in claim 6, wherein
the output section is a display section for displaying an image, and
the output control section is a display control section for causing, upon receiving flag data as the transmission disallowance data, the display section to display an image or a character indicating that the data, transmission of which has been instructed, is incapable of being transmitted because of copyright protection.

11. The reception device as set forth in claim 6, wherein
the output section is an audio output section for outputting audio, and
the output control section is an audio output control section for causing, upon receiving flag data as the transmission disallowance data, the audio output section to output audio indicating that the data, transmission of which has been instructed, is incapable of being transmitted because of copyright protection.

12. A transmission method of a transmission device which is capable of transmitting data to a reception device via a transmission route and (i) stores data under copyright protection inside the transmission device or (ii) is connectable with a storage medium storing the data under copyright protection,
said method comprising:
a copyright protection detection step for detecting whether data, transmission of which has been instructed, is under copyright protection or not based on protection information for indicating whether the data is under copyright protection or not; and
a transmission disallowance notification step for transmitting, to the reception device, transmission disallowance data indicating that the data is incapable of being transmitted because of copyright protection when it is detected that the data is under copyright protection.

13. A reception method of a reception device connected via a transmission route with a transmission device which stores data under copyright protection inside the transmission device or is connectable with a storage medium storing the data under copyright protection, said transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection,
said reception device including an output section for outputting information corresponding to the transmission disallowance data,
said reception method comprising an output step for causing, when the transmission disallowance data is received, the output section to output the information corresponding to the transmission disallowance data.

14. The reception method as set forth in claim 13, wherein
the output section is a display section for displaying an image, and
in the output step, when image data is received as the transmission disallowance data, an image corresponding to the image data is displayed on the display section.

15. The reception method as set forth in claim 13, wherein
the output section is an audio output section for outputting audio, and
in the output step, when audio data is received as the transmission disallowance data, audio corresponding to the audio data is outputted from the audio output section.

16. The reception method as set forth in claim 13, wherein
the output section is a display section for displaying an image, and
in the output step, when text data is received as the transmission disallowance data, a character corresponding to the text data is displayed on the display section.

17. The reception method as set forth in claim 13, wherein
the output section is a display section for displaying an image, and
in the output step, when flag data is received as the transmission disallowance data, an image or a character indicating that the data, transmission of which has been instructed, is incapable of being transmitted because of copyright protection is displayed on the display section.

18. The reception method as set forth in claim 13, wherein
the output section is an audio output section for outputting audio, and
in the output step, when flag data is received as the transmission disallowance data, audio indicating that the data, transmission of which has been instructed, is incapable of being transmitted because of copyright protection is outputted from the audio output section.

19. A transmission program for operating a transmission device which is capable of transmitting data to a reception device via a transmission route and (i) stores data under copyright protection inside the transmission device or (ii) is connectable with a storage medium storing the data under copyright protection, said transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection,
said program causing a computer to function as each of the sections.

20. A reception program for operating a reception device connected via a transmission route with a transmission device which stores data under copyright protection inside the transmission device or is connectable with a storage medium storing the data under copyright protection, said transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection, said reception device including: an output section for outputting information corresponding to the transmission disallowance data; and an output control section for causing, upon receiving the transmission disallowance data, the output section to output the information corresponding to the transmission disallowance data,
said program causing a computer to function as each of the sections.

21. A computer-readable storage medium for storing a transmission program for operating a transmission device which is capable of transmitting data to a reception device via a transmission route and (i) stores data under copyright protection inside the transmission device or (ii) is connectable with a storage medium storing the data under copyright protection, said transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection,
said program causing a computer to function as each of the sections.

22. A computer-readable storage medium for storing a reception program for operating a reception device connected via a transmission route with a transmission device which stores data under copyright protection inside the transmission device or is connectable with a storage medium storing the data under copyright protection, said transmission device including: a copyright protection detection section for detecting whether data, transmission of which has been instructed, is under copyright protection or not based on protection information for indicating whether the data is under copyright protection or not; and a transmission disallowance notification section for transmitting, to the reception device, transmission disallowance data indicating that the data is incapable of being transmitted because of copyright protection when it is detected that the data is under copyright protection, said reception device including: an output section for outputting information corresponding to the transmission disallowance data; and an output control section for causing, upon receiving the transmission disallowance data, the output section to output the information corresponding to the transmission disallowance data,
said program causing a computer to function as each of the sections.
